(19) United States
(12) Patent Application Publication
(10) Pub. No.: US 2025/0229440 A1
(43) Pub. Date: Jul. 17, 2025

(54) SYSTEMS AND METHODS FOR OBJECT PROCESSING USING GRIPPERS FOR OBJECTS WITH LOW POSE AUTHORITY

(71) Applicant: Berkshire Grey Operating Company, Inc., Bedford, MA (US)

(72) Inventors: Thomas ALLEN, Reading, MA (US); Jason YAP, Newton, MA (US); Ian Gerald WILSON, Melrose, MA (US); Aidan ROSE, Waban, MA (US); Mark F. BUDRESKI, Winchester, MA (US)

(21) Appl. No.: 19/063,987

(22) Filed: Feb. 26, 2025

Related U.S. Application Data
(63) Continuation of application No. 17/529,508, filed on Nov. 18, 2021, now Pat. No. 12,263,578.
(60) Provisional application No. 63/115,721, filed on Nov. 19, 2020.

(51) Int. Cl. B25J 15/06; B25J 15/04

(52) U.S. Cl. CPC B25J 15/0683; B25J 15/0408

(57) ABSTRACT

An end-effector is disclosed for a programmable motion device. The end effector includes a body that includes a vacuum portion through which a vacuum is applied to an object, and a gripping portion that is adapted to engage the object, the vacuum portion being generally orthogonal to the gripping portion.

### PRIORITY

The present application is a continuation of U.S. patent application Ser. No. 17/529,508, filed Nov. 18, 2021, which claims priority to U.S. Provisional Patent Application Ser. No. 63/115,721 filed Nov. 19, 2020, the disclosures of which are hereby incorporated by reference in their entireties.

### BACKGROUND

The invention generally relates to programmable motion systems and relates in particular to end effectors for programmable motion devices (e.g., robotic systems) for use in object processing such as object sortation and object distribution.

End effectors for robotic systems, for example, may be employed in certain applications to select and grasp an object, and then move the acquired object very quickly to a new location. Applications might include picking items from a tote of items, and then placing said item in another tote or other location. In many applications, and in order to increase the range of suitable applications, the robotic picking system must be able to pick a very large range of objects. It is therefore desirable to have the end-of-arm tool be able to grip as many items as is possible.

There are many kinds of end-of-arm tools for grasping items, including parallel grippers or finger-based grippers, as well as universal gripper or jamming gripper that uses a fluidized bed concept inside a bag, electroadhesive grippers, as well as vacuum grippers. Other techniques for acquiring and securing objects employ electrostatic attraction, magnetic attraction, needles for penetrating objects such as fabrics, fingers that squeeze an object, hooks that engage and lift a protruding feature of an object, and collets that expand in an opening of an object, among other techniques. Prehensile grippers, or finger-like grippers, for example, are sometimes used for grasping objects, but such systems also face challenges in certain applications. Such systems generally require two opposing surfaces in opposition to grasp an object, and finger-like grippers are mechanically complicated, typically requiring multiple parts as well as an actuation mechanism to close and open the fingers.

Vacuum grippers employ vacuum pressure for acquiring and securing objects for transport or subsequent operations by articulated arms. Vacuum grippers however, generally require having a good seal with an object, but ensuring a good seal sometimes requires that the particular suction cup be selected to correspond to the object being grasped. Additionally, grasping certain objects, such as plastic bags, may require a specific type of end effector to ensure that the plastic bag does not peel off of the end effector or collapse under the force of the end effector and thereby break the bag and/or the seal. Further, the lifting force may be limited by an amount proportional to the area of contact of the suction cup in a vacuum system, and the vacuum itself may damage some objects.

Many such grippers however, have considerable difficulty grasping and moving objects having low pose authority (the ability to retain a particular pose when lifted or moved). For example, FIG. 1 shows at 10 a portion of an articulated arm 12 with an end effector 14 that may be, for example, a vacuum end effector. If the object 16 in the bin 18 has low pose authority, when the object if grasped and lifted (as shown in FIG. 2), a lid 20 of the object 16 may move or rotate with respect to a base 22 of the object 16. In an automated object processing system, this not only may cause the system to have poor control of the object (since the base 22 may swing or fall away), but any contents of the object may escape between the open lid 20 and the base 22.

With further reference to FIGS. 3 and 4, even if the object (e.g., box) is grasped from a long side 24 (shown in FIG. 3) or a short side 26 (shown in FIG. 4), the contents may still escape, and the top 20 may swing or become separated from the base 22. Any of these events may be problematic in an automated object processing system, which may operate independent of human personnel.

There remains a need therefore, for an end effector in a programmable motion system that may readily grasp an object having low pose authority, and then move the acquired object very quickly to a new location.

### SUMMARY

In accordance with an aspect, the invention provides an end-effector for a programmable motion device. The end effector includes a body that includes a vacuum portion through which a vacuum is applied to an object, and a gripping portion that is adapted to engage the object, the vacuum portion being generally orthogonal to the gripping portion.

In accordance with another aspect, the invention provides an end-effector for a programmable motion device, the end-effector including a lid containment portion for facilitating retention of a lid of an object, and a gripping portion that is adapted to engage the object, the lid containment portion being generally orthogonal to the gripping portion.

In accordance with another aspect, the invention provides a programmable motion device for use in an object processing system. The programmable motion device includes an end-effector with a lid containment portion for facilitating retention of a lid of an object, and a gripping portion that is adapted to engage the object, the lid containment portion being generally orthogonal to the gripping portion.

In accordance with another aspect, the invention provides an object processing system for processing objects. The object processing system includes a programmable motion device with an end-effector, a control system for identifying potentially openable portions of the object, and an end-effector with a lid containment portion for facilitating retention of a lid of an object and a gripping portion that is adapted to engage the object.

In accordance with a further aspect, the invention provides a method of processing objects that includes identifying potentially openable portions of an object, and grasping the object with an end-effector including a lid containment portion for facilitating retention of a lid of an object, and a gripping portion that is adapted to engage the object.

### BRIEF DESCRIPTION OF THE DRAWINGS

The following description may be further understood with reference to the accompanying drawings in which:

FIG. 1 shows an illustrative diagrammatic view of an end-effector of a programmable motion device prior to grasping an object in accordance with a system of the prior art;

FIG. 2 shows an illustrative diagrammatic view of the end-effector of FIG. 1 while holding the object;

FIG. 3 shows an illustrative diagrammatic view of the end-effector of FIG. 1 while holding the object from a different grasp location;

FIG. 4 shows an illustrative diagrammatic view of the end-effector of FIG. 1 while holding the object from a further grasp location;

FIG. 5 shows an illustrative diagrammatic view of an end-effector of a programmable motion device in accordance with an aspect of the present invention;

FIG. 6 shows an illustrative diagrammatic end view of the end-effector of FIG. 5;

FIG. 7 shows an illustrative diagrammatic side view of the end-effector of FIG. 5;

FIG. 8 shows an illustrative diagrammatic bottom view of the end-effector of FIG. 5;

FIG. 9 shows an illustrative diagrammatic rear view of the end-effector of FIG. 5;

FIG. 10 shows an illustrative diagrammatic underside enlarged view of the end-effector of FIG. 5;

FIG. 11 shows an illustrative diagrammatic further enlarged view of the end-effector of FIG. 5;

FIG. 12 shows an illustrative diagrammatic enlarged end view of the end-effector of FIG. 5;

FIG. 13 shows an illustrative diagrammatic enlarged underside view of the end-effector of FIG. 5;

FIG. 14 shows an illustrative diagrammatic enlarged rear view of the end-effector of FIG. 5;

FIG. 15 shows an illustrative diagrammatic enlarged side sectional view of the end-effector of FIG. 5 taken along line 15-15 in FIG. 14;

FIG. 16 shows an illustrative diagrammatic enlarged side view of the end-effector of FIG. 5;

FIGS. 17A and 17B show illustrative diagrammatic views of an end-effector of FIG. 5 approaching a box to be grasped (FIG. 17A) and grasping the box (FIG. 17B);

FIGS. 18A and 18B show illustrative diagrammatic views of an end-effector of FIG. 5 approaching a differently oriented box to be grasped (FIG. 18A) and grasping the differently oriented box (FIG. 18B);

FIG. 19 shows an illustrative diagrammatic view of an object processing system with an end-effector of FIG. 5 in accordance with an aspect of the present invention;

FIG. 20 shows an illustrative diagrammatic enlarged view of a portion of the system of FIG. 19 showing a box being lifted from a bin;

FIG. 21 shows an illustrative diagrammatic enlarged view of a further portion of the system of FIG. 19 showing a box being placed into a box;

FIG. 22 shows an illustrative diagrammatic enlarged view of the end-effector in accordance with a further aspect of the present invention that includes barbs;

FIG. 23 shows an illustrative diagrammatic view of enlarged end view of the end-effector of FIG. 22; and

FIGS. 24A and 24B show illustrative diagrammatic views of an end-effector of FIG. 22 approaching a box to be grasped (FIG. 24A) and grasping the box (FIG. 24B);

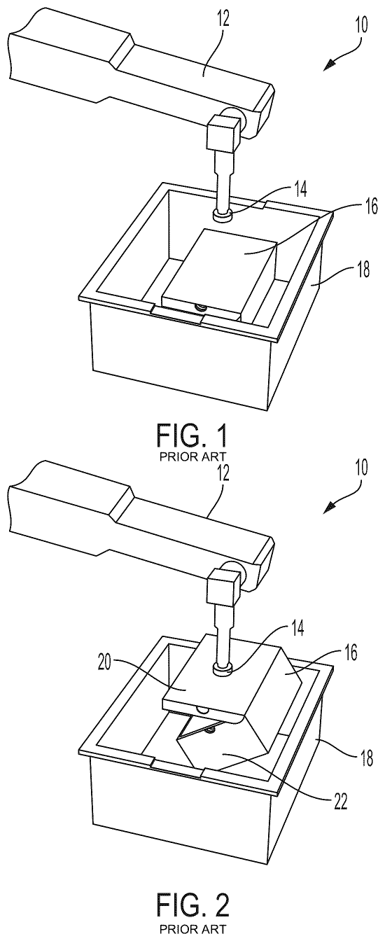

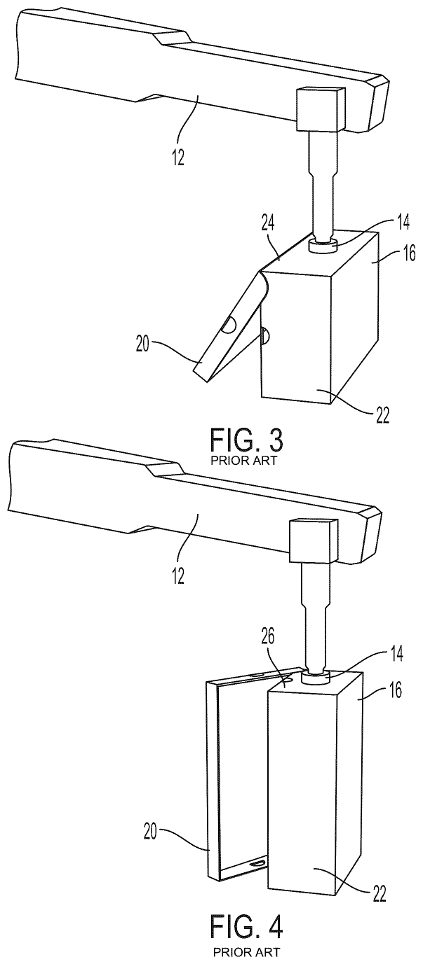

The drawings are shown for illustrative purposes only.

### DETAILED DESCRIPTION

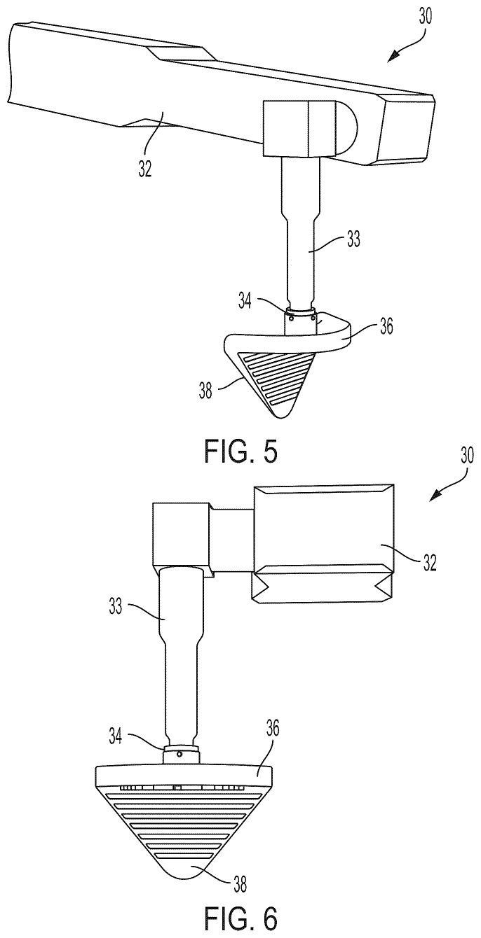

In accordance with an aspect, the invention provides an end-effector that may be used with a programmable motion device in an object processing system for processing objects having low pose authority. FIG. 5 for example, shows at 30 a portion of an articulated arm 32 of a programmable motion device that includes an end-effector 34 in accordance with an aspect of the invention. FIG. 5 shows an isometric view of the end-effector 34, which includes a first portion 36 by which a vacuum is applied to an object and that facilitates containing a lid of an object as discussed further below. The end-effector 34 further includes a second portion 38 that may engage a side of an object as also discussed in more detail below.

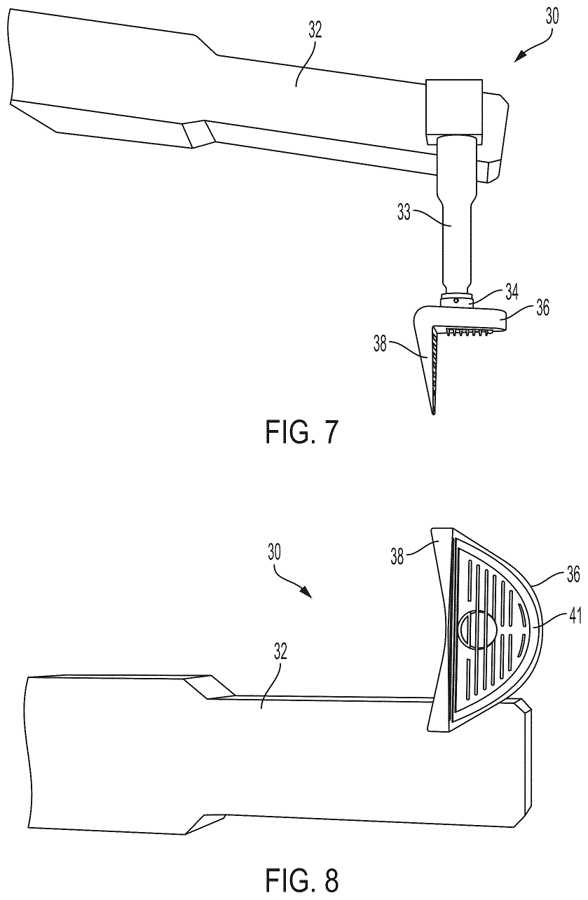

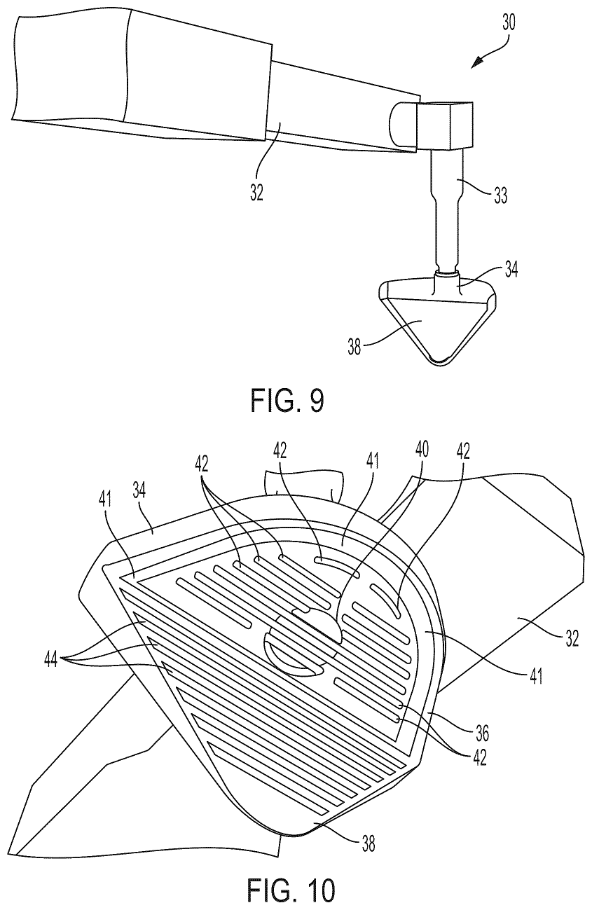

FIG. 6 shows a front view of the end-effector 34 with the second portion 38 facing forward. The end-effector 34 may be rotated by rotating the end-effector connection portion 33 (to which the end-effector 34 is connected) of the articulated arm 32. The first portion 36 and the second portion 38 of the end-effector 34 may be generally mutually orthogonal. FIG. 7 shows a side view of the end-effector 34 showing the general relative positional/orientation relationship between the first portion 36 and the second portion 38 of the end-effector 34. FIG. 8 shows a bottom view of the end-effector 34 with the first portion 36 facing downward, and FIG. 9 shows a rear view of the end-effector 34.

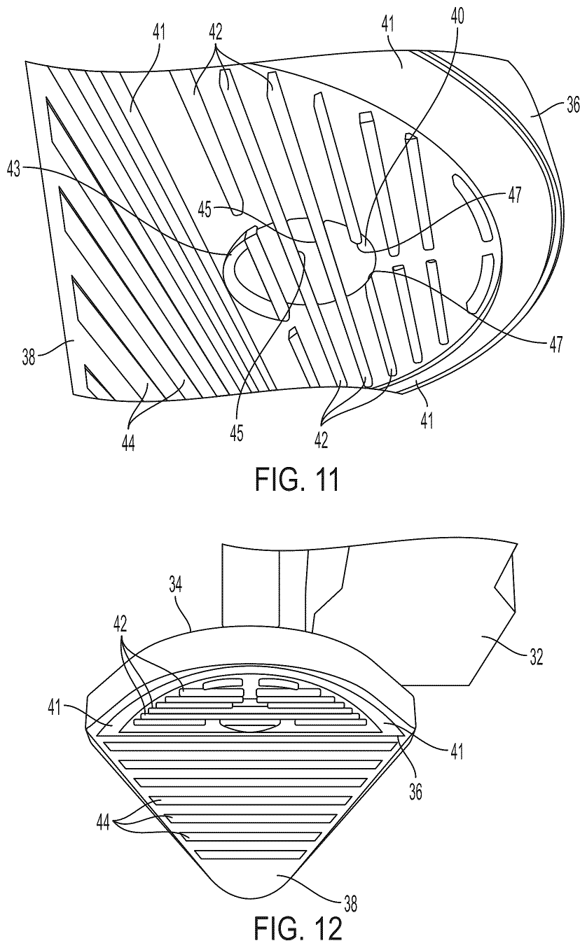

FIG. 10 shows an enlarged view of the first portion 36 of the end-effector 34, including a vacuum opening 40 coupled to a vacuum source. The vacuum source, for example, may be provided by a blower (with a vacuum pressure that is higher than a vacuum pressure provided by the ejector). The vacuum source therefore, may provide a vacuum pressure of no more than about 25,000 Pascals below atmospheric, with a maximum air flow rate of, for example, at least about 100 cubic feet per minute (e.g., 130-140 cubic feet per minute). The first portion 36 further includes ridges 42 (some of which cross the opening 40 as shown at 45), and the ridges facilitate distribution of the vacuum over a contact surface of the object. At least one ridge may be formed as part of a closed area 43 over the vacuum opening 40, while one or more other ridges may be open over the vacuum opening 40 as shown at 47. In this way, a portion of the vacuum opening may include a closed area of vacuum (e.g., 43), while in other areas the ridges provide vacuum flow (e.g., at 45) in a first direction (along the ridges), while in further areas, the ridge(s) may further provide vacuum flow (e.g., at 47) in a second direction (through the opening in the ridge) that is orthogonal with respect to the first direction. In this way, some portion(s) may provide more seal against the object than other portions, with the closed area providing the most seal, the ridge areas 45 providing less of a seal (due to vacuum flow along the ridges), and the ridge opening shown at 47 providing even less of a seal (due to vacuum flow along the ridges through the opening at 47). Variable levels of seal and air flow may therefore be provided in different areas at the interface of the first portion 36 and the box being grasped, permitting lighter boxes to be held by the seal, while heavier boxes are further held by the high flow vacuum.

As also shown in FIG. 10, the second portion 38 of the end-effector 34 includes non-slip surfaces 44 formed, for example, of rubber, cork, adhesive, or electro-static material etc. FIG. 11 shows an enlarged view of the first portion 36 of the end-effector 34 of FIG. 10, and FIG. 12 shows an enlarged front view of the second portion 38 of the end-effector 34 of FIG. 10. A foam or rubber seal 41 may encircle the ridges 42 and aperture 40 on the underside of the first portion 36 to facilitate the application of a vacuum to an object. The height of the foam or rubber seal 41 may be at least as high as the height of the ridges 42.

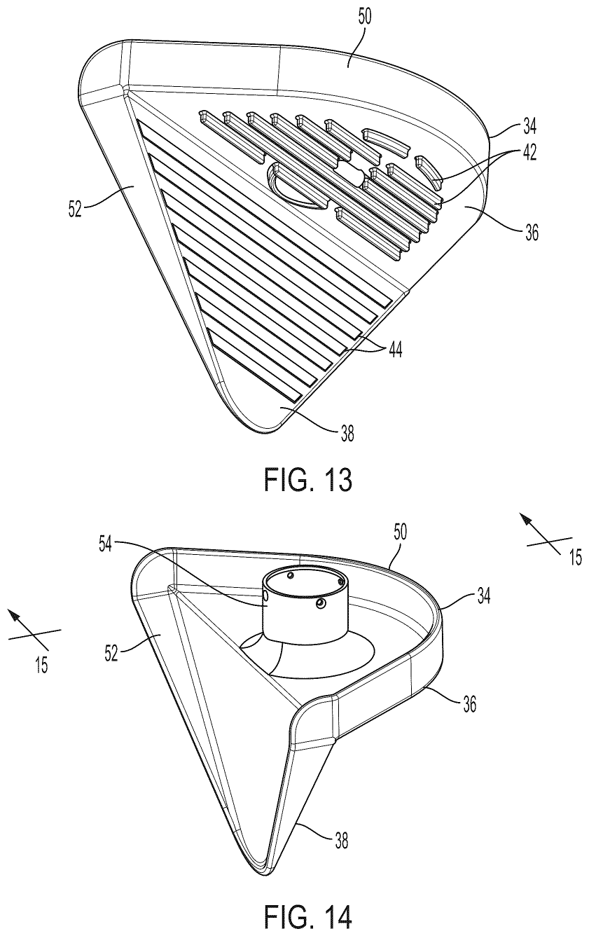

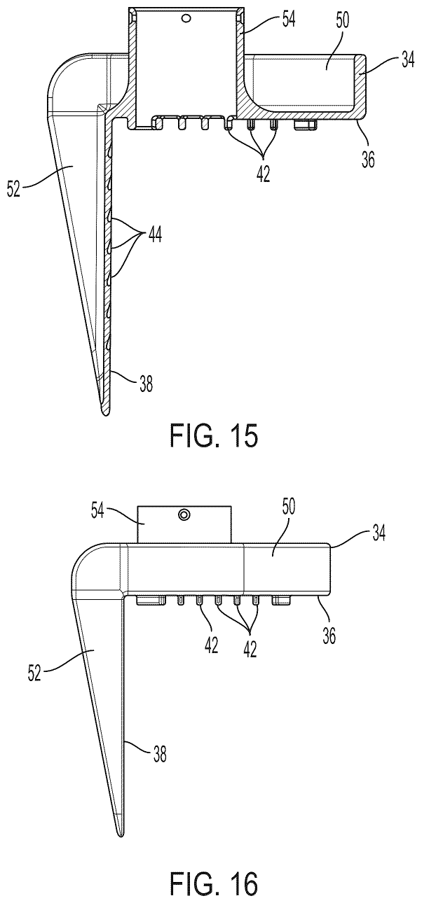

FIG. 13 shows a more detailed underside view of the end-effector 34 showing the ridges 36 of the first portion 36, and the non-slip surfaces 44 of the second portion 38, as well as outer wall 50 of the first portion 36 and outer wall 52 of the second portion 38. FIG. 14 shows a rear view of the end-effector 34 of FIG. 13 showing the walls 50, 52, as well as a coupling member 54 for connecting to the end-effector connection portion 33 discussed above. FIG. 15 shows a side-sectional view of the end-effector 34 of FIG. 14 taken along a center of the end-effector 34 shown at 15-15. FIG. 16 shows a side view of the end-effector 34 of FIG. 14.

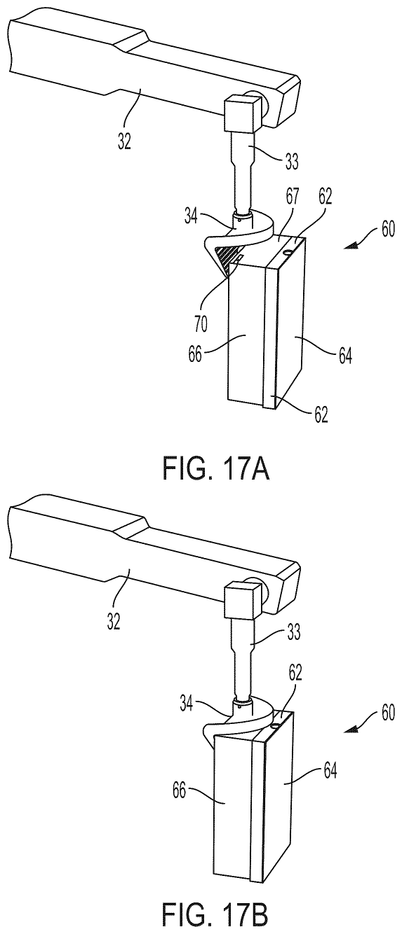

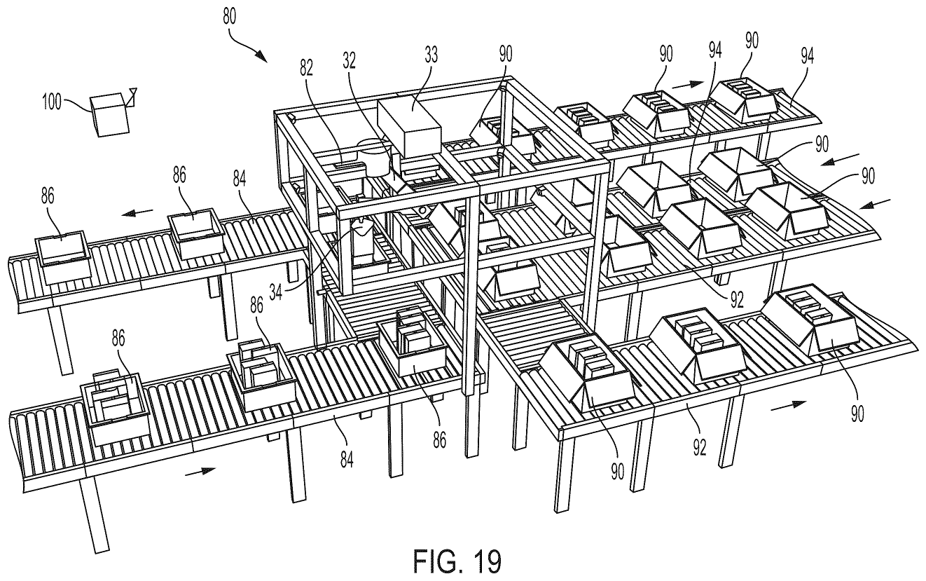

The object processing system (as discussed in further detail below with reference to FIG. 19) may include one or more perception units for viewing objects. The perception units are in communication (e.g., wirelessly) to one or more computer processing systems, in part, for identifying grasp locations. The system initially identifies whether the object is any of a category of objects having potentially poor pose authority. For example, objects that appear to be box-shaped or cube-shaped are analyzed for containing potentially exposed or lose flaps. FIG. 17A for example, shows an object 60 that is cube-shaped and includes three flaps 62 (two are shown) that are attached to a top 64 and that overlap a box base 66. The end-effector 34 may be selected to grasp the object 60 such that the first portion of the end-effector 34 contacts the base 66 and at least a portion of one of the flaps 62 along a short side 67 of the box 60 as shown in FIG. 17B. The second portion 38 of the end-effector 34 contacts the underside of the base 66.

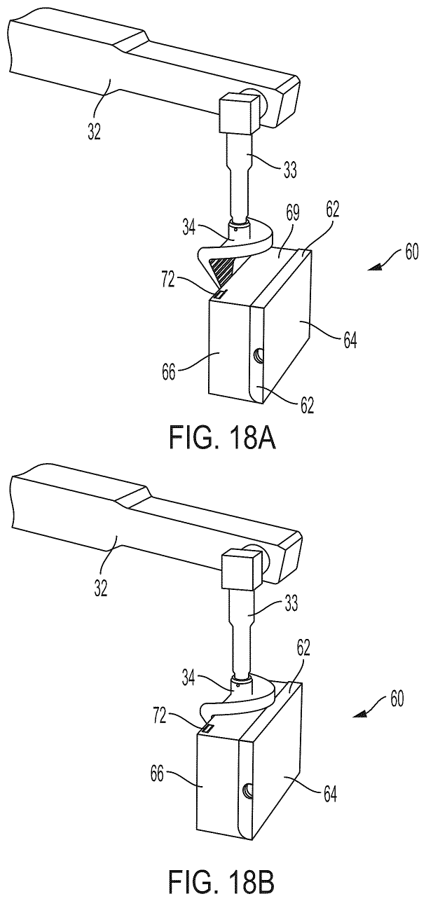

FIG. 18A also shows the object 60 that is cube-shaped and includes three flaps 62 (again, two are shown) that are attached to a top 64 and that overlap a box base 66. The end-effector 34 may similarly be selected to grasp the object 60 such that the first portion of the end-effector 34 contacts the base 66 and at least a portion of one of the flaps 62 along a long side 69 of the box 60 as shown in FIG. 18B. The second portion 38 of the end-effector 34 contacts the underside of the base 66. Additionally, identifying indicia 70 and/or 72 on the box (as shown in FIGS. 17A and 18A) may be identified by the object processing system. The identifying indicia may be used, in combination with a warehouse manifest, to determine a destination location for each box.

The system may therefore include one or more perception units located on or near an infeed conveyor for identifying indicia on an exterior of each of the bins, providing perception data from which the contents of the bin may be identified, and then knowing its relative position on the conveyor, track its location. It is assumed, in accordance with an aspect, that the bins of objects are marked in one or more places on their exterior with a visually distinctive mark such as a barcode (e.g., providing a UPC code), QR code, or radio-frequency identification (RFID) tag or mailing label so that they may be sufficiently identified with a scanner for processing. The type of marking depends on the type of scanning system used, but may include 1D or 2D code symbologies. Multiple symbologies or labeling approaches may be employed. The types of scanners employed are assumed to be compatible with the marking approach. The marking, e.g. by barcode, RFID tag, mailing label or other means, encodes a identifying indicia (e.g., a symbol string), which is typically a string of letters and/or numbers. The symbol string uniquely associates the vendor bin with a specific set of homogenous objects.

On the selected infeed conveyor at the object processing station, the perception system assists (using the central control system 100—e.g., one or more computer processing systems) the programmable motion device including the end-effector in locating and grasping an object in the infeed bin. In accordance with further aspects, each object may also be marked with a visually distinctive mark, again such as a barcode (e.g., providing a UPC code), QR code, or radio-frequency identification (RFID) tag or mailing label so that they may be sufficiently identified with a scanner for processing. The type of marking depends on the type of scanning system used, but may include 1D or 2D code symbologies. Again, multiple symbologies or labeling approaches may be employed on each object.

With reference to FIG. 19, the object processing system 80 may include a perception system 82 that looks down in the object processing station and perceives perception data from one or more objects on an infeed conveyor 84. Objects to be processed may arrive on the infeed conveyor 84 in bins 86. Objects may be processed by placing each object into a designated destination location box 90 that my run along either of two output conveyors 92, 94. A vacuum source 33 provides the high flow vacuum to the end-effector. The perception system 82 is mounted above a bin of objects to be processed, and the perception system 82 may include (on the underside thereof), a camera, a depth sensor and lights. A combination of 2D and 3D (depth) data may be acquired. The depth sensor may provide depth information that may be used together with the camera image data to determine depth information regarding possible flaps on the various objects in view. The lights may be used to remove shadows and to facilitate the identification of edges of objects, and may be all on during use, or may be illuminated in accordance with a desired sequence to assist in object and flap identification. The system uses this imagery and a variety of algorithms to generate a set of candidate grasp locations for the objects that include a flap in the bin as discussed in more detail below.

The system will identify candidate grasp locations that include a portion of a flap on one or more objects, and may not try to yet identify a grasp location for the object that is partially obscured by other objects. Candidate grasp locations may be indicated using a 3D model of the robot end effector placed in the location where the actual end effector would go to use as a grasp location. Grasp locations may be considered good, for example, if they are close to the center of mass of the object to provide greater stability during grasp and transport, and/or if they avoid places on an object such as caps, seams etc. where a good vacuum seal might not be available.

If an object cannot be fully perceived by the detection system, the perception system considers the object to be two different objects, and may propose more than one candidate grasps of such two different objects. If the system executes a grasp at either of these bad grasp locations, then it will either fail to acquire the object due to a bad grasp point where a vacuum seal will not occur, or it will acquire the object at a grasp location that is very far from the center of mass of the object, thereby inducing a great deal of instability during any attempted transport. Each of these results is undesirable.

If a bad grasp location is experienced, the system may remember that location for the associated object. By identifying good and bad grasp locations, a correlation is established between features in the 2D/3D images and the idea of good or bad grasp locations. Using this data and these correlations as input to machine learning algorithms, the system may eventually learn, for each image presented to it, where to best grasp an object, and where to avoid grasping an object.

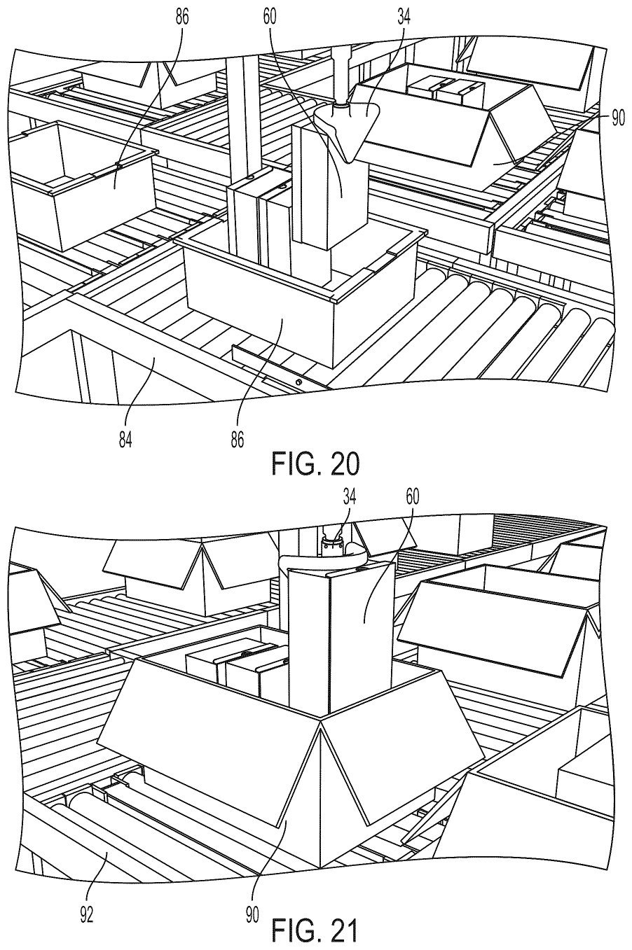

With further reference to FIG. 20, an object 60 may be removed from a bin 86, and with reference to FIG. 21, the object 60 may be placed into the appropriate box 90. The conveyors 84, 92, 94 may include bi-direction sections to aid in turning, or may be provided as straight conveyors that are all within a reach of the articulated arm 32. Additional sensors may be provided along the conveyors to identify bins and boxes, and to track their locations.

Again, the operations of the system described above are coordinated with a central control system 100 that again communicates (e.g., wirelessly) with the articulated arm, the perception units, as well as in-feed conveyor and output conveyors. This system determines from symbol strings the UPC associated with a vendor bin, as well as the outbound destination for each object. The central control system 100 is comprised of one or more workstations or central processing units (CPUs). For example, the correspondence between UPCs or mailing labels, and outbound destinations is maintained by a central control system in a database called a manifest. The central control system maintains the manifest by communicating with a warehouse management system (WMS). The manifest provides the outbound destination for each in-bound object.

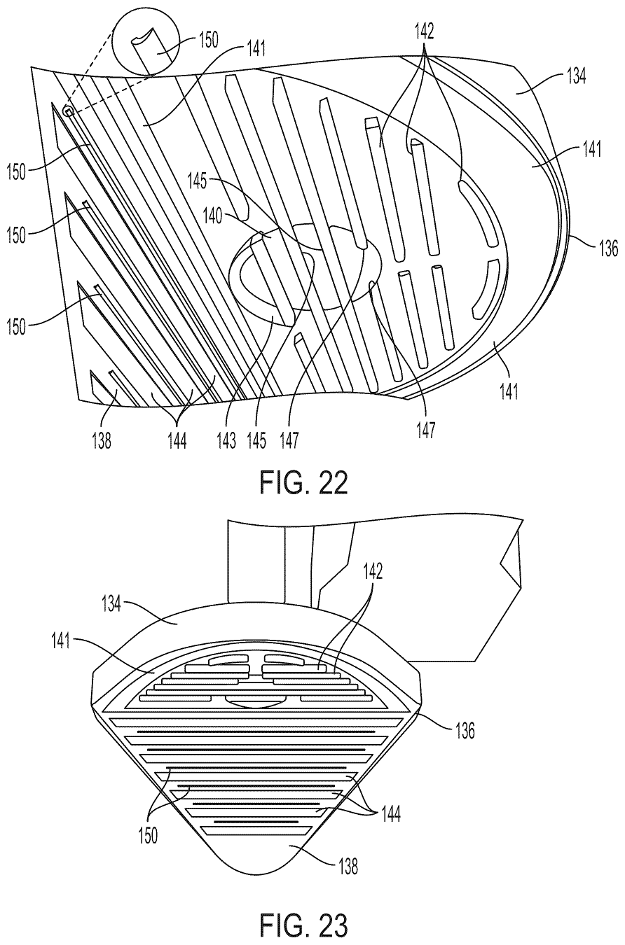

FIG. 22 shows an underside view of an end-effector 134 in accordance with a further aspect of the invention that includes a first portion 136 including a vacuum opening 140 coupled to a vacuum source and through which a vacuum may be provided to an object. The first portion 136 further includes ridges 142 (some of which cross the opening 140), and the ridges facilitate distribution of the vacuum over a contact surface of the object. As also shown in FIG. 23, the second portion 138 of the end-effector 134 includes non-slip surfaces 144 formed, for example, of rubber, cork, adhesive, or electro-static material etc. as well as rows of angle barbs 150, that are angled upward toward the first portion 136 to engage a side of a box. FIG. 22 shows an enlarged view of the first portion 136 of the end-effector 134, and FIG. 23 shows an enlarged front view of the second portion 138 of the end-effector 134. A foam or rubber seal 141 may encircle the ridges 142 and aperture 140 on the underside of the first portion 136 to facilitate the application of a vacuum to an object. The height of the foam or rubber seal 141 may be at least as high as the height of the ridges 142.

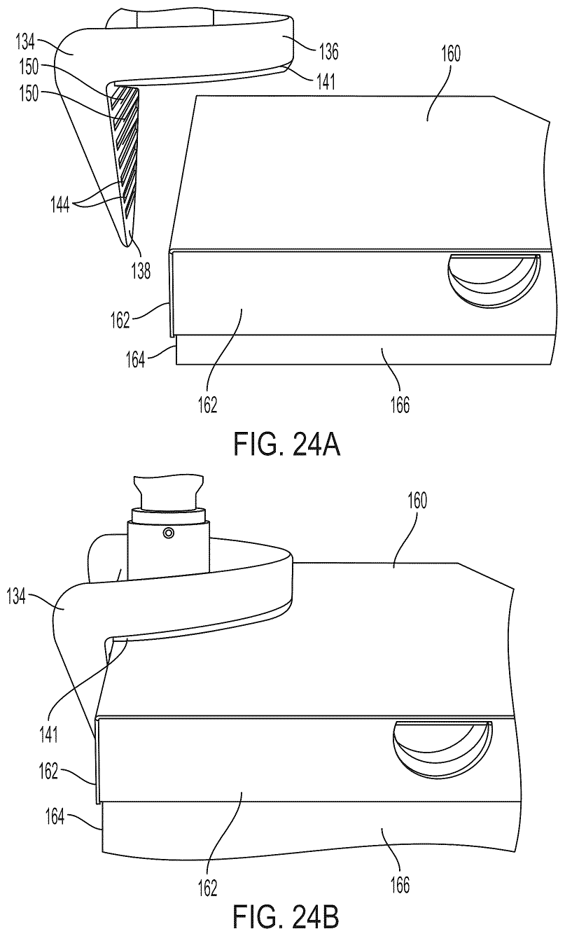

FIG. 24A shows the end-effector 134 approaching a box such that the ridges 142 on the first portion 136 will engage a top 160 of the box, and both the non-slip surfaces 144 and the rows of barbs 150 will engage both a portion of a flap 162 as well as a side wall 164 of a base 166 of the box as further shown in FIG. 24B. In this way, a box having low pose authority may even be grasped with the first portion 136 contacting the top 160 of the box since the second portion 138 may sufficiently engage the side wall 164 of the base 166. In accordance with certain aspects, the vacuum source may be switchable to change to a source of positive air pressure that is pushed from the source to the apertures to urge an object away from the contact surface in accordance with certain aspects of the invention.

Those skilled in the art will appreciate that numerous modifications and variations may be made to the above disclosed embodiments without departing from the spirit and scope of the present invention.

What is claimed is:

1.-40. (canceled)

41. An end-effector for a programmable motion device, the end-effector comprising:
a body including a first planar contact surface and a second planar contact surface, the first planar contact surface and the second planar contact surface providing an orthogonal relationship and conforming to a corner of an object with a right angle relationship between a top of the object and a side of the object;
the body coupled to the programmable motion device with a high flow vacuum supply with a flowrate of at least 100 cubic feet per minute provided therein;
the first planar contact surface including a vacuum opening coupled to the vacuum supply;
the first planar contact surface including a first plurality of ridges, the first plurality of ridges providing vacuum flow to the vacuum supply in a first direction and vacuum flow in a second direction, the first direction being orthogonal to the second direction; and
the second planar contact surface including a second plurality of ridges.

42. The end-effector as claimed in claim 41, wherein the second plurality of ridges on the second planar contact surface have a non-slip surface.

43. The end-effector as claimed in claim 42, wherein the non-slip surface is formed from at least one of rubber, cork, adhesive, and electro-static material.

44. The end-effector as claimed in claim 41, wherein the second plurality of ridges on the second planar contact surface includes barbs.

45. The end-effector as claimed in claim 41, wherein the first planar contact surface further comprises a compliant seal encircling the first plurality of ridges.

46. The end-effector as claimed in claim 45, wherein the compliant seal is at least as high as the ridges.

47. The end-effector as claimed in claim 41, wherein the body is rotatably coupled to the programmable motion device.

48. An end-effector for a programmable motion device, the end-effector comprising:
a body including a first planar contact surface and a second planar contact surface, the first planar contact surface and the second planar contact surface providing an orthogonal relationship and conforming to a corner of an object with a right angle relationship between a top of the object and a side of the object;
the body coupled to the programmable motion device with a vacuum supply provided therein;
the first planar contact surface including a vacuum opening coupled to the vacuum supply;
the first planar contact surface including a first plurality of ridges, the plurality of ridges providing open vacuum flow to the vacuum supply in a first direction and vacuum flow in a second direction, the first direction being orthogonal to the second direction;
the first plurality of ridges encircled by a compliant seal; and
the second planar contact surface including a second plurality of ridges.

49. The end-effector as claimed in claim 48, wherein the compliant seal has a height that is at least as high as a height of the first plurality of ridges.

50. The end-effector as claimed in claim 48, wherein the vacuum supply is provided by a blower with a pressure of no more than about 25,000 Pascals below atmospheric pressure and at least about 100 cubic feet per minute.

51. The end-effector as claimed in claim 50, wherein the vacuum supply is provided with a flow rate between 130 and 140 cubic feet per minute.

52. The end-effector as claimed in claim 48, wherein the second plurality of ridges on the second planar contact surface have a non-slip surface.

53. The end-effector as claimed in claim 42, wherein the non-slip surface is formed from at least one of rubber, cork, adhesive, and electro-static material.

54. The end-effector as claimed in claim 41, wherein the second plurality of ridges on the second planar contact surface includes barbs.

55. An end-effector for a programmable motion device, the end-effector comprising:
a body coupled to a distal end of the programmable motion device;
the body including a first planar contact surface and a second planar contact surface, the first planar contact surface and the second planar contact surface providing an orthogonal relationship and conforming to a corner of an object with a right angle relationship between a top of the object and a side of the object;
a high flow vacuum supply providing at least 100 cubic feet per minute vacuum flow fluidically connected to only a vacuum port on the first planar contact surface; and
the end-effector, when presented to grasp a cuboid object comprising a hinged lid, lifts the object from the hinged lid using the high flow vacuum supply while the second planar contact surface constrains the cuboid object from rotation to prevent the hinged lid from opening.

56. The end-effector as claimed in claim 55, wherein the first planar contact surface has a plurality of ridge features to distribute vacuum to the first contact surface.

57. The end-effector as claimed in claim 56, wherein the first planar contact surface further comprises a compliant seal surrounding the plurality of ridge features.

58. The end-effector as claimed in claim 55, wherein the second planar contact surface comprises a plurality of ridges including a non-slip surface.

59. The end-effector as claimed in claim 58, wherein the non-slip surface is formed from at least one of rubber, cork, adhesive, and electro-static material.

60. The end-effector as claimed in claim 55, wherein the second plurality of ridges on the second planar contact surface includes barbs.
